(19) United States
(12) Patent Application Publication
(10) Pub. No.: US 2012/0162026 A1
(43) Pub. Date: Jun. 28, 2012

(54) ANTENNA ARRANGEMENT FOR A PORTABLE RADIO COMMUNICATION DEVICE HAVING A METAL CASING

(76) Inventors: M. Charlotta Andersson, Solna (SE); Per Erlandsson, Stockholm (SE); Göran Johansson, Jarfalla (SE); Ulf Palin, Ljustero (SE); Axel von Arbin, Taby (SE); Johan Bäckman, Taby (SE)

(21) Appl. No.: 13/313,985

(22) Filed: Dec. 7, 2011

(30) Foreign Application Priority Data
Dec. 22, 2010 (EP) 10196640.6

(51) Int. Cl. H01Q 1/24

(52) U.S. Cl. 343/702

(57) ABSTRACT

Exemplary embodiments are disclosed of antenna arrangements for portable radio communication devices. In an exemplary embodiment, there is an antenna arrangement for a portable communication device having a metal casing. The antenna arrangement generally includes a front side part of the metal casing. A first back side part is connected to the front side part through a top side part of the metal casing. A second back side part is connected to the front side part through a bottom side part of the metal casing. The bottom and top side parts are positioned at opposite ends of the front side part. The first and second back side parts are positioned and distanced from each other by a gap.

### CROSS REFERENCE TO RELATED APPLICATION

This application claims priority to European application No. EP 10196640.6 filed Dec. 22, 2010. The entire disclosure of the above application is incorporated herein by reference.

### FIELD

The present disclosure relates generally to antennas for radio communication devices, and particularly to antenna arrangements for portable radio communication devices having metal casings.

### BACKGROUND

This section provides background information related to the present disclosure which is not necessarily prior art.

A current trend for portable radio communication devices, such as mobile phones, PDA, portable computers, and similar devices, is to provide the device with a metal casing. A metal casing for a portable radio communication device makes it difficult to provide the device with a non-protruding antenna, as the metal casing shields the interior of the device for radio frequencies. It is heretofore possible to only partly provide the casing as a metal casing to allow the use of a built in antenna. But the inventors hereof have recognized that it would be desirable to provide the casing as a full metal casing.

Another trend for portable radio communication devices, such as mobile phones and similar devices, is to provide the device with a wide coverage of frequency band covering, for example, GSM850, GSM900, GSM1800, GSM1900, UMTS 2100 MHz, GPS, BT (Bluetooth), and WLAN 2.4 GHz, etc. This puts further restrictions on the design of an antenna for a portable radio communication device.

### SUMMARY

This section provides a general summary of the disclosure, and is not a comprehensive disclosure of its full scope or all of its features.

Exemplary embodiments are disclosed of antenna arrangements for portable radio communication devices. In an exemplary embodiment, there is an antenna arrangement for a portable communication device having a metal casing. The antenna arrangement generally includes a front side part of the metal casing. A first back side part is connected to the front side part through a top side part of the metal casing. A second back side part is connected to the front side part through a bottom side part of the metal casing. The bottom and top side parts are positioned at opposite ends of the front side part. The first and second back side parts are positioned and distanced from each other by a gap.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically shows a front side of a metal casing for a mobile phone.

FIG. 2 schematically shows a back side of a metal casing for a mobile phone according to a first embodiment.

FIG. 3 schematically shows a side view from the left of a variant of the metal casing shown in FIG. 2.

FIG. 4 schematically shows a side view from the right of a variant of the metal casing shown in FIG. 2.

FIG. 5 schematically shows a back side of a metal casing for a mobile phone according to a second embodiment.

FIG. 6 schematically shows a back side of a metal casing for a mobile phone according to a third embodiment.

FIG. 7 schematically shows a back side of a metal casing for a mobile phone according to a fourth embodiment.

FIG. 8 schematically shows a side view of a metal casing for a mobile phone according to a fifth embodiment.

FIG. 9 schematically shows a side view of a metal casing for a mobile phone according to a sixth embodiment.

FIG. 10 schematically shows a side view of a metal casing for a mobile phone according to a seventh embodiment.

FIG. 11 schematically shows a back side and a side view of a metal casing for a mobile phone according to an eighth embodiment.

Corresponding reference numerals indicate corresponding parts throughout the several views of the drawings.

### DETAILED DESCRIPTION

Example embodiments will now be described more fully with reference to the accompanying drawings.

Accordingly, exemplary embodiments disclosed herein provide an antenna arrangement for a portable radio communication device having a metal casing, while still allowing or accommodating for a non-protruding antenna. In an exemplary embodiment, there is provided an antenna arrangement for a portable radio communication device having a metal casing. In this exemplary embodiment of antenna arrangement, there is a front side part of the metal casing. A first back side part is connected to the front side part through a top side part of the metal casing. A second back side part is connected to the front side part through a bottom side part of the metal casing. The bottom and top side parts are positioned at opposite ends of the front side part. The first and second back side parts are positioned and distanced from each other by a gap. A portable radio communication device having a metal casing and a non-protruding antenna can be provided via this exemplary embodiment.

In exemplary embodiments, a broad high-frequency band is facilitated by preferably having a feed point positioned at the gap of the first back side part. The feed point is further preferably positioned at a corner of the first back side part, to further facilitate providing the broad high-frequency band. The second back side part is advantageously provided with a feed point at the gap, preferably at a corner opposite the feed point of the first back side part, to facilitate providing a broad low-frequency band.

To broaden the high and low frequency bands, the first and second back side parts preferably comprise side edge portions folded down towards the front side part in exemplary embodiments. In addition, the first and second back side parts preferably have gap edge profiles that are mirrored to each other, for example, to accommodate a camera in the gap in exemplary embodiments.

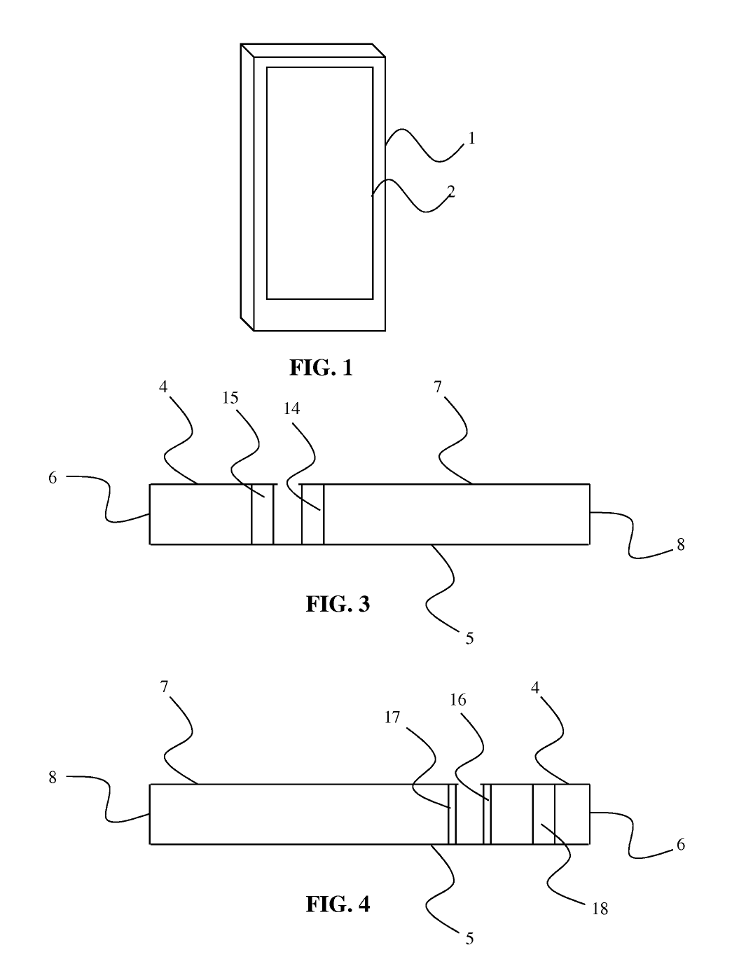

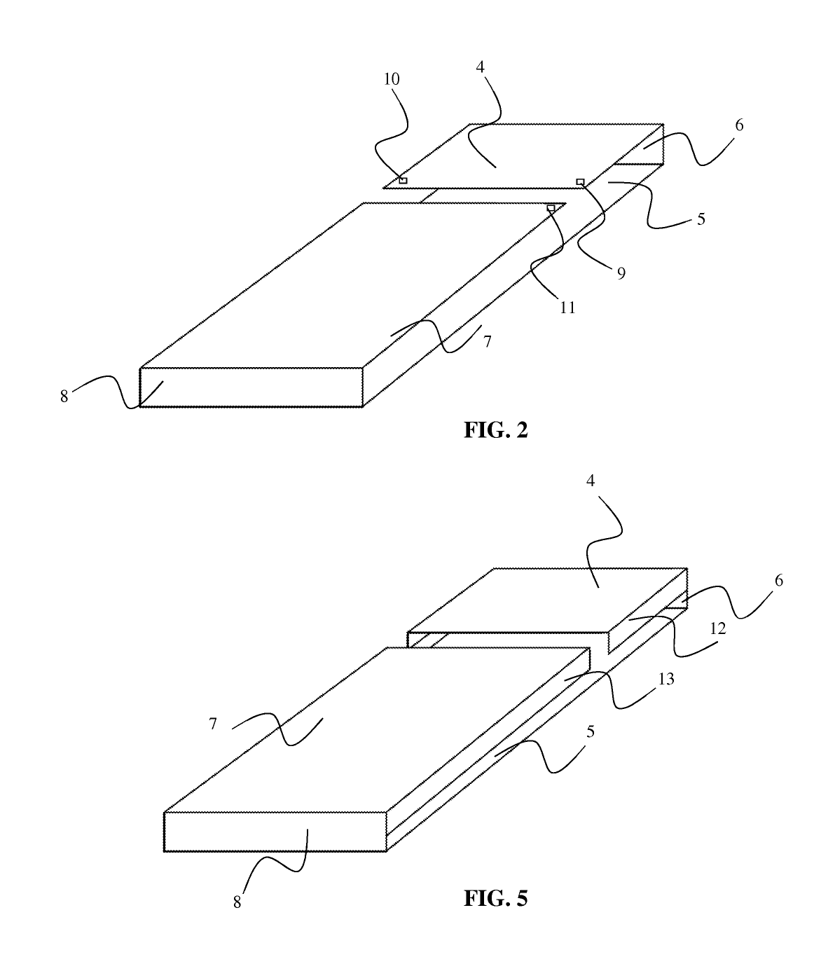

With reference now to the figures, FIGS. 1 and 2 illustrate a portable radio communication device comprising a metal casing and an antenna arrangement according to a first embodiment. As shown in FIG. 1, the portable radio communication device, such as a mobile phone, has a sheet metal casing 1 and a display 2 mounted in a front side part of the sheet metal casing 1. Components for operation of the portable radio communication device are as usually provided within its housing, which in this case would be within the sheet metal casing 1. The display 2 is preferably a touch-screen display, but could alternatively, for example, be provided with a display and a separate key pad.

The back piece of the metal casing 1 is divided into two parts. A first back side part 4 is connected to the front side part 5 of the metal casing through a top side part 6. A second back side part 7 is connected to the front side part 5 of the metal casing through a bottom side part 8. The first back side part 4 and the second back side part 7 are positioned and distanced from each other by a gap of about 2 to 5 millimeters (mm).

The first back side part 4 is driven as a multi-band high-frequency antenna element by being fed at a feed point 9, preferably at a corner near the gap against the second back side part 7 and by being grounded along the top side part 6. For improved functionality, the first back side part 4 is preferably also grounded at a ground point 10 at an opposite corner near the gap against the second back side part 7 or at the side edge nearer the top side part 6. For a mobile phone, and thus its metal casing, having a length of about 110 mm, a width of about 50 mm, and a thickness of about 9 mm, a frequency band coverage of about 1550-2500 MHz is achievable. The first back side part 4 has a generally rectangular shape having a length of about 33 mm and a width of about 50 mm in this example.

The second back side part 7 is driven as a multi-band low-frequency antenna element by being fed at a feed point 11 at a corner near the gap against the first back side part 4, and by being grounded along the bottom side part 8. For a mobile phone, and thus its metal casing, having a length of about 110 mm, a width of about 50 mm, and a thickness of about 9 mm, a frequency band coverage of about 750-1050 MHz is achievable. The second back side part 7 has a generally rectangular shape having a length of about 72 mm and a width of about 50 mm in this example.

The first and second back side parts are functioning as radiating elements over a ground plane (over the front side part). In this way, a robust antenna is achieved by the first and second back side parts respectively connected to the front side through a large grounding means, which in this example are the top and bottom side parts, respectively. A display device and/or a key pad are typically provided with grounded shielding means between the interior of the radio communication device and the display device and/or the key pad. The grounded shielding means then form part of the front side part. Further, in a mobile phone e.g. having a touch-screen display occupying essentially the whole front thereof, the front side part of the metal casing will then be made up by the shielding means of the touch-screen display.

The first and second back side parts have been described as having feed points 9 and 11. Feeding of the feed points 9 and 11 is advantageously provided as two separate feedings to radio frequency (RF) circuitry, to help improve isolation therebetween. But the feeding of the feed points 9 and 11 could alternatively be provided as a common feeding having filtering means to separate signaling to and from RF circuitry.

The second back side part 7 preferably covers the whole battery of a mobile phone. The second back side part is preferably pivotable around and/or detachably attached to the bottom side part to facilitate access into the mobile phone, e.g., for changing battery or for changing a subscriber identity module (SIM) of the mobile phone.

The top and bottom side parts have been illustrated as parts covering the top and bottom side, respectively, of the portable radio communication device. But the top and bottom side parts can alternatively comprise a plurality of grounding portions together not covering the top or bottom side, respectively.

For improved antenna function the metal casing is preferably made up by, or metalized by, a good conductive material.

For tuning of the antenna made up by the metal casing 1, additional grounding is preferably added at the sides of the portable radio communication device. For example, FIG. 3 illustrates a wide grounding 15 to ground point 10 as well as a wide grounding 14 of the second back side part. As another example, FIG. 4 illustrates an additional wide grounding 18 of the first back side part. FIG. 4 also illustrates feeding 16 to feed point 9 and feeding 17 to feed point 11.

Although the first back side part has been described as generating the high frequency band and the second back side part has been described as generating the low frequency band, the opposite is also possible. Also, either the first or the second back side part could generate both low and high frequency bands.

Although the antenna arrangement has been shown having a straight gap, it could alternatively be a curved gap or comprise a cut-out, e.g., for accommodating a camera in the gap. Preferably, the first and second back side parts have gap edge profiles that are mirror-shaped in exemplary embodiments.

FIG. 5 illustrates an antenna arrangement according to a second embodiment. This second embodiment is similar to the first embodiment described above apart from that the first and second back side parts comprises folded side edge portions extending towards the front side part, extending about 6 millimeters (mm) and thus leaving a gap of about 3 mm to the front side part. Although the folded side edge portions have been illustrated as covering the whole first and second back side parts, it is also possible to only have portions of the first and second back side part edges folded towards the front side part.

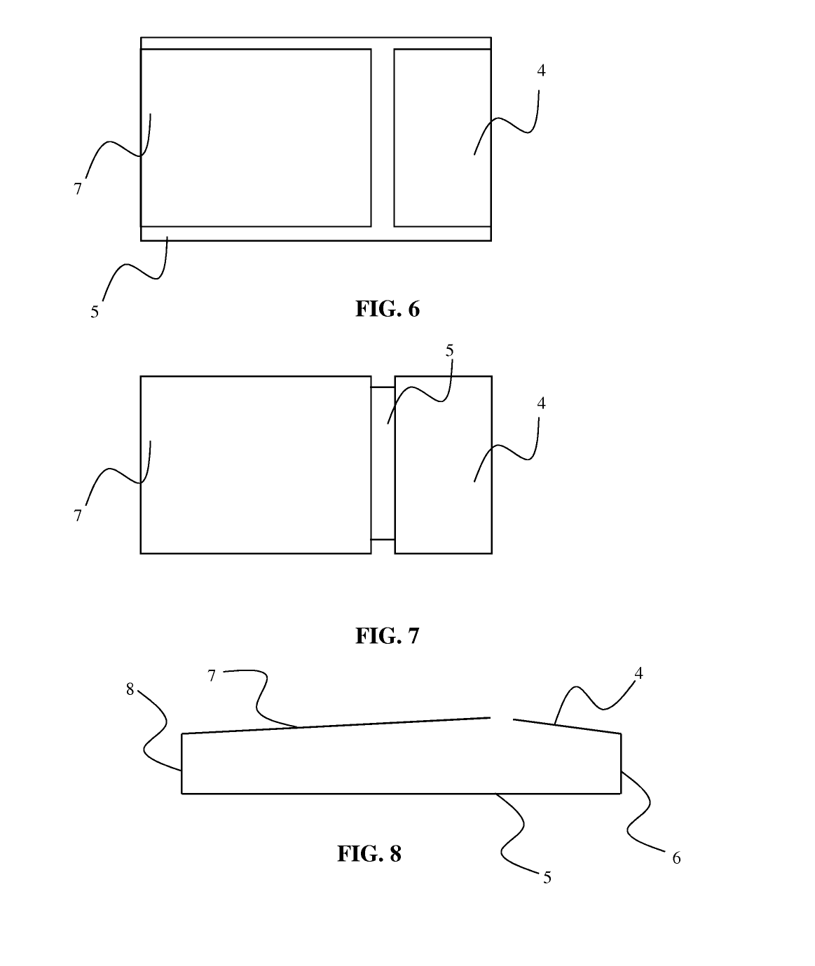

FIG. 6 illustrates an antenna arrangement according to a third embodiment. This third embodiment is similar to the first embodiment described above apart from that the front side part 5 edges are folded towards the back side parts, and the first 4 and second 7 back side parts have a smaller extension than the front side part. The form of the gap is thus H-shaped in the back piece of the portable radio communication device.

FIG. 7 illustrates an antenna arrangement according to a fourth embodiment. This fourth embodiment is similar to the first embodiment described above apart from that the front side part 5 has a smaller extension than the back side parts 4 and 7, and the frequency band coverage of the antenna elements are thus increased by the antenna elements being partly off-ground.

FIG. 8 illustrates an antenna arrangement according to a fifth embodiment. This fifth embodiment is similar to the first embodiment described above apart from that the first and second back side parts 4 and 7 are non-coplanar. The distance between the back side parts and the front side part are greatest at the gap and smallest at the top and bottom side parts. In this way, the portable radio communication device can be adapted to rounded edges, thus allowing lower thickness in the outer portions of the portable radio communication device.

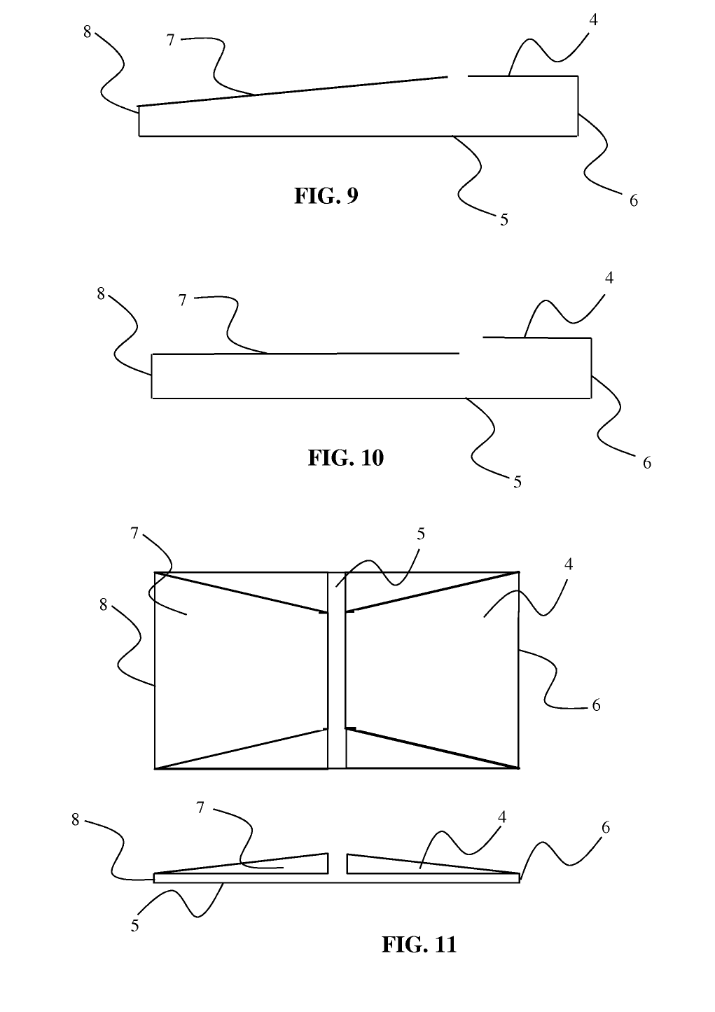

FIG. 9 illustrates an antenna arrangement according to a sixth embodiment. This sixth embodiment is similar to the fifth embodiment described above apart from the first back side part is planar and parallel to the front side part and the second back side part is tapered towards the bottom side part. In this way the portable radio communication device can, for example, be adapted to rounded edges, thus allowing lower thickness in the outer portions of the portable radio communication device.

FIG. 10 illustrates an antenna arrangement according to a seventh embodiment. This seventh embodiment is similar to the first embodiment described above apart from that the distance between the second back side part and the front side part is smaller than the distance between the first back side part and the front side part. In this way, the portable radio communication device can, for example, be adapted to different volume requirements for different parts of the portable radio communication device.

FIG. 11 illustrates an antenna arrangement according to an eighth embodiment. This eighth embodiment is similar to the fifth embodiment described above apart from that the first and second back side parts are tapered both towards the top and bottom side parts as well as towards the side edge parts. This further facilitates thinner portable radio communication devices, as well as rounded edges all around the portable radio communication device.

The dimensions provided herein are for purposes of illustration only as the particular dimensions may vary depending on the particular application. The particular dimensions and values provided are not intended to limit the scope of the present disclosure.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter. The disclosure of a first value and a second value for a given parameter can be interpreted as disclosing that any value between the first and second values could also be employed for the given parameter. Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An antenna arrangement for a portable radio communication device having a metal casing, said antenna arrangement comprising:
a front side part of said metal casing;
a first back side part connected to said front side part through a top side part of said metal casing;
a second back side part connected to said front side part through a bottom side part of said metal casing;
wherein said bottom and top side parts are positioned at opposite ends of said front side part;
wherein said first and second back side parts are positioned and distanced from each other by a gap; and
wherein said first back side part comprises a feed point positioned at the gap.

2. The antenna arrangement according to claim 1, wherein said feed point is positioned at a corner at said gap.

3. The antenna arrangement according to claim 1, wherein said first and second back side parts have gap edge profiles that are mirrored to each other.

4. The antenna arrangement according to claim 1, wherein said second back side part comprises a feed point positioned at said gap.

5. The antenna arrangement according to claim 4, wherein said feed point of said second back side part is positioned at a corner at said gap.

6. The antenna arrangement according to claim 5, wherein said feed point of said second back side part is positioned adjacent said feed point of said first back side part.

7. The antenna arrangement according to claim 1, wherein said second back side part comprises a ground point.

8. The antenna arrangement according to claim 1, wherein said first and second back side parts comprises edge portions folded towards said front side part.

9. The antenna arrangement according to claim 1, wherein said first back side part comprises a ground point.

10. The antenna arrangement according to claim 1, wherein said first and/or said second back side parts protrude outside of said front side part.

11. The antenna arrangement according to claim 1, wherein said first and said second back side parts are non-coplanar.

12. A portable radio communication device comprising the antenna arrangement of claim 1.

13. An antenna arrangement for a portable radio communication device having a metal casing, said antenna arrangement comprising:
a front side part of said metal casing;
a first back side part connected to said front side part through one of a top side part and a back side part of said metal casing;
a second back side part connected to said front side part through the other one of said top side part and said bottom side part of said metal casing;
wherein said bottom and top side parts are positioned at opposite ends of said front side part;
wherein said first and second back side parts are positioned and distanced from each other by a gap; and
wherein said first back side part comprises a feed point positioned at the gap.

14. The antenna arrangement according to claim 13, wherein said first back side part is connected to said front side part through said top side part, and wherein said second back side part is connected to said front side part through said bottom side part.

15. The antenna arrangement according to claim 13, wherein said first back side part is connected to said front side part through said bottom side part, and wherein said second back side part is connected to said front side part through said top side part.

16. A portable radio communication device comprising the antenna arrangement of claim 13.

17. A portable radio communication device comprising a metal casing and an antenna arrangement, the antenna arrangement comprising:
a front side part of said metal casing;
a first back side part connected to said front side part through one of a top side part or bottom side part of said metal casing;
a second back side part connected to said front side part through the other one of said top side part and said bottom side part;
wherein said bottom and top side parts are positioned at opposite ends of said front side part;
wherein said first and second back side parts are positioned and distanced from each other by a gap; and
wherein said first back side part comprises a feed point positioned at the gap.

18. The portable radio communication device according to claim 17, wherein said first back side part is connected to said front side part through said top side part, and wherein said second back side part is connected to said front side part through said bottom side part.

19. The portable radio communication device according to claim 17, wherein said first back side part is connected to said front side part through said bottom side part, and wherein said second back side part is connected to said front side part through said top side part.

20. The portable radio communication device according to claim 17, wherein the portable radio communication device is a mobile phone.
